(19) United States
(12) Patent Application Publication
(10) Pub. No.: US 2010/0033468 A1
(43) Pub. Date: Feb. 11, 2010

(54) PORTABLE DISPLAY DEVICES AND PROGRAMS

(75) Inventor: Hiroki Sugamata, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/538,108

(22) Filed: Aug. 7, 2009

(30) Foreign Application Priority Data
Aug. 7, 2008 (JP) 2008-204438

(51) Int. Cl. G06F 3/038

(52) U.S. Cl. 345/211

(57) ABSTRACT

A portable display device transitions between a first state and a second state, and includes a display portion to display information in the first state and to display particular information in the second state, a power source that supplies power in the first state, and supplies less power in the second state than in the first state, and a controller that drives the display portion to display information in the display portion. The controller replaces the particular information displayed in the display portion with a further information different from the information displayed in the display portion, by transitioning the portable display device from the second state to the first state, and back to the second state, at a predetermined timing.

### CROSS REFERENCE TO RELATED APPLICATION

The present application claims priority from Japanese Patent Application No. 2008-204438, which was filed on Aug. 7, 2008, the disclosure of which is incorporated herein by reference in its entirety.

### BACKGROUND OF THE INVENTION

1. Field of the Invention

The present invention relates to portable display devices and programs, and more particularly to portable display devices and programs for maintaining a display image or information in the portable display devices even when power from a power source is turned off.

2. Description of Related Art

A known portable display device, e.g., electronic paper viewer, e.g., a device described in Japanese Laid-Open Patent Publication No. 2007-187927, includes a non-volatile display portion configured to maintain display information, e.g., an image, even when power supply from a power source is turned off. The portable display device is configured to maintain information, which was displayed in the non-volatile display device immediately before power is turned off, in a state of power-off. Therefore, a user may view the information even in a state of power-off. The above-described display device may constantly display the information, which was displayed immediately before power is turned off, in a state of power-off. Therefore, the same information may be maintained until the information is rewritten or replaced with another information when the device is used again.

### SUMMARY OF THE INVENTION

Therefore, a need has arisen for portable display devices which overcome these and other shortcomings of the related art. A technical advantage of the present invention is that a portable display device and a program for changing information to be displayed in the display device in a power-off state

In an embodiment of the invention, a portable display device is configured to transition between a first state and a second state, and the portable display device comprises a display portion configured to display information when the portable display device is in the first state and to display a particular information when the portable display device is in the second state, a power source configured to supply power when the portable display device is in the first state, and to supply less power when the portable display device is in the second state than when the portable display device is in the first state, and a controller configured to drive the display portion to display information in the display portion. The controller is configured to replace the particular information displayed in the display portion with a further information different from the information displayed in the display portion, by transitioning the portable display device from the second state to the first state, and back to the second state, at a predetermined timing.

In another embodiment of the invention, a computer program product has computer readable instructions stored thereon. When executed by a processor of a portable display device, the computer readable instructions configure the processer to perform the steps of driving a display portion to display information when the portable display device is in a first state, the first state corresponding to the portable display device receiving a power supply from a power source, displaying a particular information when the portable display device is in a second state, the second state corresponding to the portable display device receiving less power from the power source than when the portable display device is in the first state, transitioning the portable display device from the second state to the first state, replacing the particular information with a further information different from the information displayed in the display portion, transitioning the portable display device from the first state to the second state, and displaying the further information when the portable display device returns to the second state.

Other objects, features, and advantages of embodiments of the present invention will be apparent to persons of ordinary skill in the art from the following description of preferred embodiments with reference to the accompanying drawings.

### BRIEF DESCRIPTION OF THE DRAWINGS

For a more complete understanding of the present invention, the needs satisfied thereby, and the objects, features, and advantages thereof, reference now is made to the following description taken in connection with the accompanying drawings.

FIG. 1 is a front view of a portable display device according to an embodiment of the invention.

FIG. 2 is a schematic showing an electrical configuration of the portable display device, an external device and a server, according to an embodiment of the invention.

FIGS. 3A and 3B are schematics showing power-off display tables, according to an embodiment of the invention.

FIGS. 4A-4F are schematics showing an electrophoretic display device of the portable display device, according to an embodiment of the invention.

FIGS. 5A-5F are schematics showing power-off display information displayed in the electrophoretic display portion, according to an embodiment of the invention.

FIG. 6 is a flowchart showing a process performed in the portable display device, according to an embodiment of the invention.

FIG. 7 is a flowchart showing a process performed in the portable display device, according to an embodiment of the invention.

FIG. 8 is a flowchart showing a process performed in the portable display device, according to an embodiment of the invention.

FIG. 9 is a flowchart showing a process performed in the portable display device, according to an embodiment of the invention.

FIG. 10 is a flowchart showing a process performed in the portable display device, according to an embodiment of the invention.

FIG. 11 is a flowchart showing operations performed in the external device, according to an embodiment of the invention.

FIG. 12 is a flowchart showing operations performed in the portable display device and the server, according to an embodiment of the invention.

FIG. 13 is a flowchart showing operations performed in the portable display device and the server, according to an embodiment of the invention.

### DETAILED DESCRIPTION OF EMBODIMENTS OF THE INVENTION

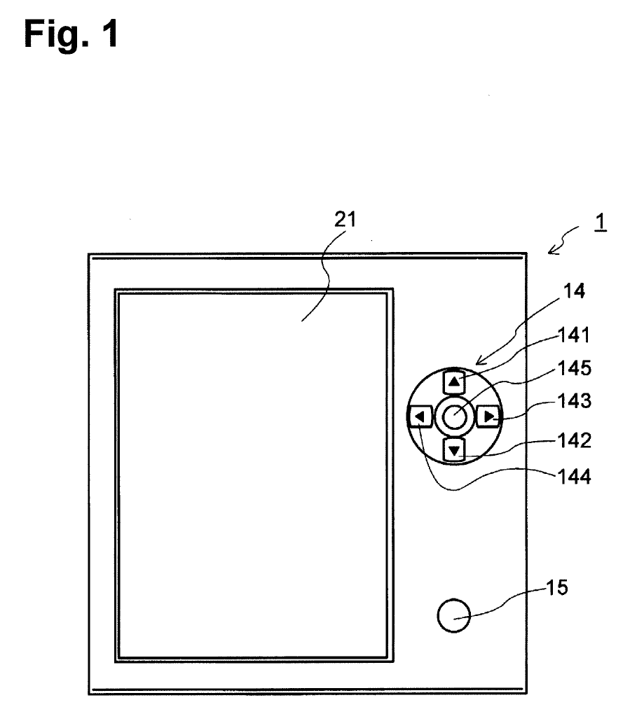

Embodiments of the present invention and their features and technical advantages may be understood by referring to FIGS. 1-13, like numerals being used for like corresponding portions in the various drawings.

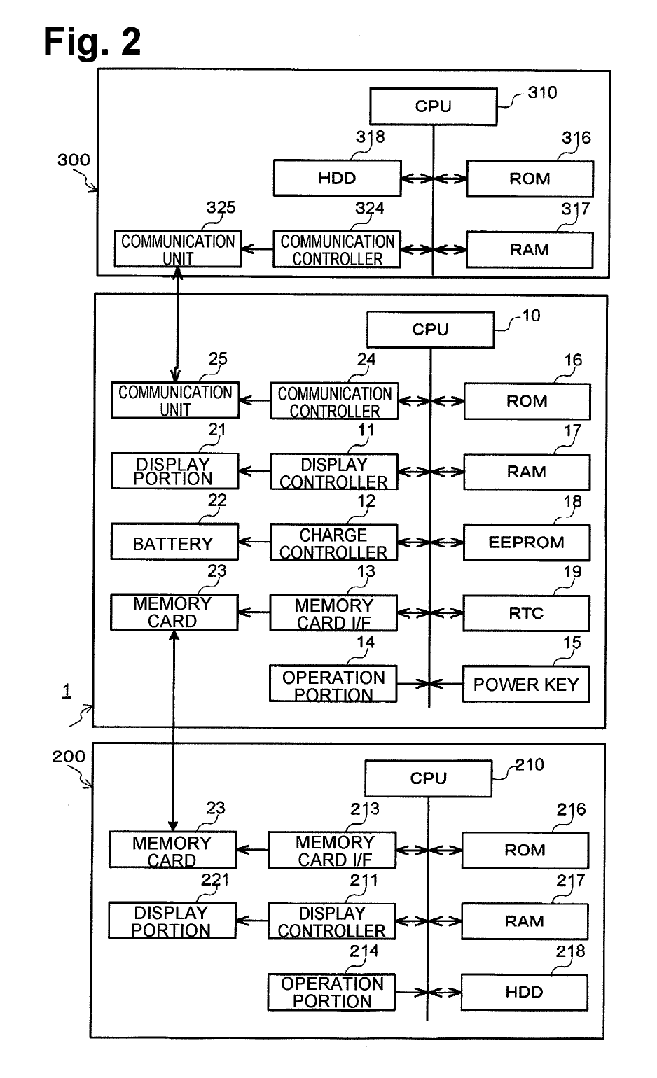

Referring to FIG. 1, a portable display device 1 according to an embodiment of the present invention may have a substantially rectangular parallelepipedonal shape. Portable display device 1 may comprise a non-volatile display portion 21, e.g., an electrophoretic display portion. Display portion 21 may be disposed on a front surface of portable display device 1. A right side of portable display device 1 in FIG. 1 may comprise a card slot (not shown) into which a memory card 23 in FIG. 2 may be inserted. Portable display device 1 may display contents, e.g., contents stored in memory card 23, on display portion 21. In this embodiment, information, e.g., at least one of a text, a freeze-frame image, and a moving image, may be displayed based on the contents. Content data may comprise at least one piece of data for displaying a text, a freeze-frame image, and a moving image.

Portable display device 1 in FIG. 1 may comprise operation keys 14 that may be operated by a user. In an embodiment of the invention, as shown in FIG. 1, operation keys 14 may be positioned to the right of and substantially adjacent to electrophoretic display portion 21. Operation keys 14 may comprise at least an enter key 145, and an up arrow key 141, a down arrow key 142, a right arrow key 143 and a left arrow key 144. Keys 141, 142, 143, and 144 may be disposed on the upper, lower, right and left side of enter key 145, respectively. For example, up arrow key 141 and down arrow key 142 may be used to select a content in a screen listing contents or a menu screen. Right arrow key 143 and left arrow key 144 may be used to turn pages of a content displayed in electrophoretic display portion 21. A content stored in memory card 23 may be displayed in display portion 21 or instructions for various settings may be provided, with the operations of operation keys 14 according to the information displayed in display portion 21 or the screen displayed in display portion 21. Moreover, a power key 15 may be disposed on a portion of device 1 below operation keys 14 in FIG. 1. Power key 15 may provide instructions for turning power on or off.

Referring to FIG. 2, device 1 may comprise a central processing unit (“CPU”) 10, a display controller 11, a charge controller 12, a memory card interface (“I/F”) 13, operation keys 14, power key 15, a read-only memory (“ROM”) 16, a random access memory (“RAM”) 17, an electrically erasable programmable read-only memory (“EEPROM”) 18, a real time clock (“RTC”) 19, a communication controller 24 and a communication unit 25.

CPU 10 may perform control of device 1. ROM 16 may store various data and programs for operating device 1. ROM 16 may store various data and programs for operating device 1. RAM 17 may temporarily store various data. EEPROM 18 may be a non-volatile memory. RTC 19 may measure time. Display controller 11 may control a display in the display portion 21, to display information therein. Memory card I/F 13 may control reading of data from memory card 23, and writing of data into memory card 23. Communication controller 24 may control communication unit 25 to allow communication unit 25 to communicate with other devices, e.g., a server 300. Device 1 may be driven by power supplied from a battery 22 when power is not supplied from an external power source (not shown). Battery 22 may be a rechargeable type of battery. There may be two power supply routes from a power source, e.g., battery 22 or the external power source, one for CPU 10 and the other for peripheral devices, such as ROM 16, RAM 17, EEPROM 18, and display controller 11. Charge controller 12 may control a delivery of charge to battery 22 from the external power source.

Device 1 may be configured to transition between a first state, e.g., a power-on state, in which power is supplied to device 1 and the components which device 1 comprises, and a second state, e.g., a power-off state, in which power is not supplied to device 1 and the components which device 1 comprises. These states will be discussed in more detail herein.

When device 1 is in a power-off state, pressing power key 15 or any of operation keys 14, may cause an instruction to turn power on to be provided. Upon receipt of this instruction, CPU 10 may transition to a normal operation mode, and the peripheral devices may receive power supplied from the power source. Thus, device 1 may be brought into an operational state. When device 1 is in a power-on state, pressing power key 15 may cause an instruction to turn power off to be provided. Upon receipt of this instruction, Power supply to the peripheral devices may be suspended or stopped, and CPU 10 may transition to a power-saving mode in which CPU 10 consumes less power than in its normal operation mode. When device 1 is in a power-on state, and a user does not operate any operation keys 14 for a predetermined period of time, e.g., a power-off setting time, device 1 may be determined to be in a non-operating state. In an embodiment of the invention, power key 15 may be disposed in device 1. In another embodiment of the invention, power key 15 may be omitted, and any key may function as power key 15 by pressing and holding the key for a predetermined amount of time.

In an embodiment of the invention, when device 1 is in a power-off state, any one or any combination of the following conditions may be true:

(1) Power supply to at least one of the peripheral devices, e.g., RAM 17, controllers such as display controller 11, display portion 21, may be suspended or stopped; and

(2) At least one of the peripheral devices may be placed in a power-saving mode in which power consumption may be reduced below a level of power consumption when the at least one of the peripheral devices operates in a power-on operation mode;

(3) CPU 10 may be placed in the power-saving mode.

Device 1 may transition to the power-off when one or more of the following events occur: (1) when power key 15 is pressed; (2) when any of operation keys 14 are not pressed for a predetermined period of time; (3) when the remaining amount of battery 22 becomes smaller than a predetermined amount; and (4) when power is not supplied from battery 22 because battery 22 runs out.

Display portion 21 may be a non-volatile display portion and may maintain display information when power supply is suspended from the power source to display portion 21. Thus, the display information may be viewed in display portion 21 even while power is saved, e.g., in a power-off state.

Device 1 may be configured to read data from, or write data into, an external device 200, e.g., via memory card 23. External device 200 may be configured to provide device 1 with data of a content body, e.g., a document, and data regarding the information to be displayed in display portion 21, in association with the content, when the device 1 power is turned off, e.g., when device 1 is in a power-off state. The information to be displayed in display portion 21 in a power-off state may be hereinafter simply referred to as “power-off display information.”

As shown in FIG. 2, device 200 may comprise a central processing unit (“CPU”) 210, a display controller 211, a memory card interface (“I/F”) 213, an operation portion 214, a read-only memory (“ROM”) 216, a random access memory (“RAM”) 217, a hard disk drive (“HDD”) 218, and a display portion 221. CPU 210 may perform control of device 200. ROM 216 may store various data and programs for operating device 200. RAM 217 may temporarily store various data. HDD 218 may be a non-volatile storage medium configured to store various data for device 200. Display controller 211 may control display portion 221 to display information therein. Memory card I/F 213 may control reading data from and writing data into a memory device, e.g., memory card 23.

Device 200 may be used to provide device 1 with data of a content, via memory card 23. Device 200 may also be used to set power-off display information, which may be associated with a content. Device 1 may communicate with server 300 via a network, e.g., a communication network (not shown). Server 300 may be configured to provide device 1 with data of a content, e.g., a document, and data of power-off display information associated with the content.

Server 300 may comprise a central processing unit (“CPU”) 310, a read-only memory (“ROM”) 316, a random access memory (“RAM”) 317, a hard disk drive (“HDD”) 318, a communication controller 324, and a communication unit 325. CPU 310 may perform control of server 300. ROM 316 may store various data and programs for operating server 300. RAM 317 may temporarily store various data. HDD 318 may be a non-volatile storage medium configured to store various data for server 300. Communication controller 324 may control communication unit 325 to allow communication unit 325 to communicate with other devices, e.g., device 1. Server 300 may be used to provide device 1 with data of a content, via the communication network (not shown) and to update power-off display information corresponding to a content.

Display portion 21 may comprise an electrophoretic display panel (not shown), a gate driver (not shown) configured to output a gate signal to respective gate lines of the electrophoretic display panel, and a source driver (not shown) configured to output a source signal to respective source lines of the electrophoretic display panel. Display controller 11 of device 1 may be configured to control the gate drive and the source driver of display portion 21. Display controller 11 may receive a rewriting instruction from CPU 10, and may rewrite information displayed in display portion 21, based on the received rewriting instruction. The electrophoretic display panel may be an active matrix type. The electrophoretic display panel may comprise a transparent substrate positioned on a front side, e.g., a viewing side, and a rear substrate positioned opposite to the transparent substrate.

Electrophoretic display elements may be positioned between the transparent substrate and the rear substrate. The active matrix type-display panel may be configured to rewrite information displayed in display portion 21 by applying voltage to a common electrode positioned on the transparent substrate and a pixel electrode positioned on the rear substrate for each pixel. As the gate driver and the source driver receive the rewriting instruction from display controller 11, the date driver and the source driver may be configured to output a gate signal and a source signal corresponding to the information to be rewritten, to the gate lines and the source lines, respectively. A voltage for controlling the electrophoretic display elements may be applied to each pixel electrode to rewrite information displayed in the display panel.

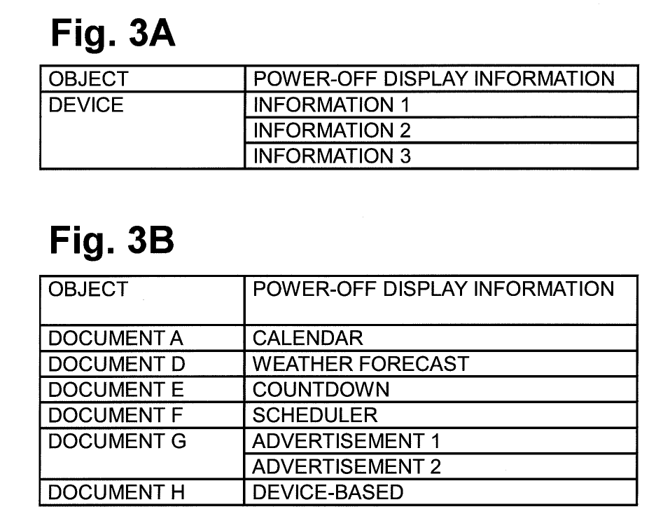

FIGS. 3A and 3B refer to a power-off display table used to determine power-off display information, according to an embodiment of the invention. The power-off display table may comprise a power-off display table for device, as shown in FIG. 3A, and a power-off display table for contents, as shown in FIG. 3B. The power-off display table for device may store settings of power-off display information for device 1. The power-off display table for contents may store settings of power-off display information for each of contents. The power-off display table may be stored in EEPROM 18 or memory card 23. In an embodiment of the invention, the power-off display table for device may be stored in EEPROM 18, and the power-off display table for contents may be stored in memory card 23.

Operation keys 14 or operation portion 214 may be operated to update, add, or change the settings of the power-off display information in the power-off display table. The power-off display table may store settings of the power-off display information corresponding to an object for which power-off display information is set, as shown in FIGS. 3A and 3B.

When using the device-based setting, the power-off display information may be determined based on the settings in the power-off display table for device. The device-based setting may be set only in the power-off display table for contents. The device-based setting may be set to a content as a default setting. For example, the device-based setting may be set to document H in the power-off display table for contents, as shown in FIG. 3B. When this setting is used, then when power is turned off while document H is displayed in display portion 21, the power-off table for device 1, as shown in FIG. 3A, may be referred to and information 1, information 2 and information 3 may appear in display portion 21 accordingly.

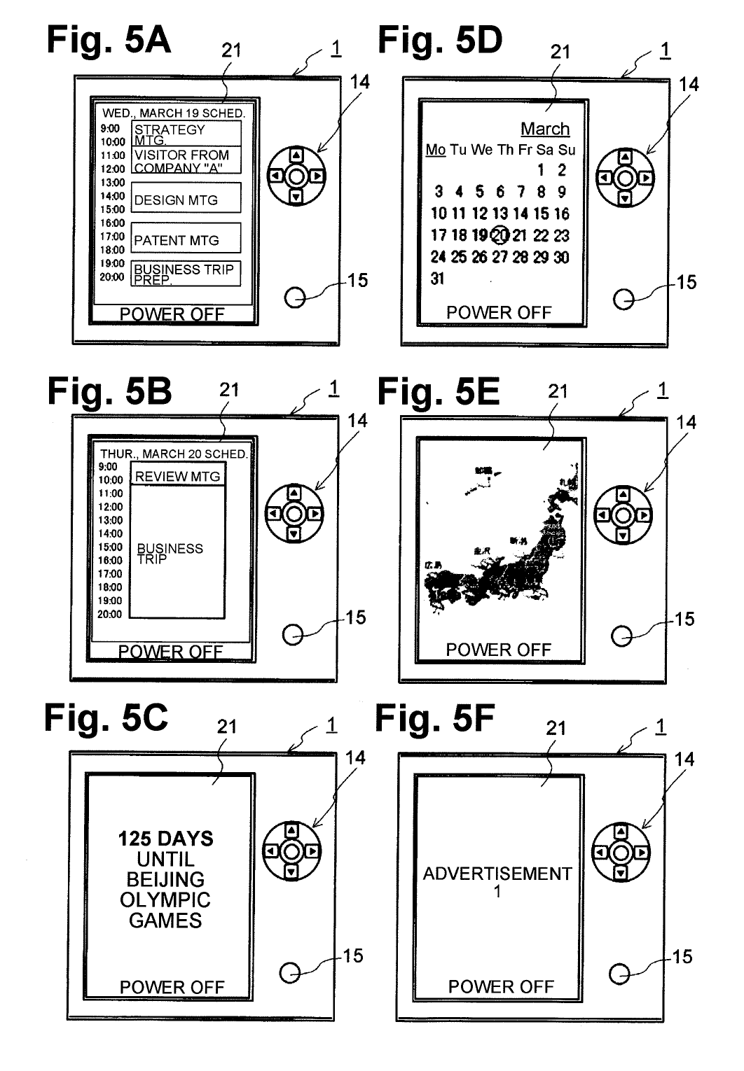

In an embodiment of the invention, updatable or non-updatable power-off display information may be set to an object in the power-off display table. The updatable power-off display information may display a plurality of pieces of information. For example, the updatable power-off display information may be a schedule, e.g., as shown in FIGS. 5A and 5B, a countdown to a date of an event, e.g., as shown in FIG. 5C, a calendar, e.g., as shown in FIG. 5D, and a weather forecast that may be updated at certain times, e.g., as shown in FIG. 5E. As shown in FIG. 3B, updatable power-off information may be set, for example, to each of documents A, D, E, and F.

The non-updatable power-off display information may display one piece of information, e.g., information 1-3, as shown in FIG. 3A. Similarly, advertisements 1 and 2 may be set to document G, as shown in FIG. 3B. A plurality of pieces of power-off display information may be set to one object, e.g., as shown in FIG. 3A, as well as shown in FIG. 3B, e.g., both advertisement 1 and advertisement 2 may be set to document G. Even if non-updatable power-off display information is set to one object, a plurality of pieces of information may be changeably displayed in display portion 21 when device 1 is in a power-off state, by setting a plurality of pieces of power-off display information to one object.

EEPROM 18, memory card 23, or both, may store the power-off display table, as described above. EEPROM 18 and memory card 23 may also store contents data, as well as data corresponding to images relating to, for example, information 1-3, calendar, weather forecast, countdown, scheduler, and advertisements 1 and 2, that may be set as power-off display information.

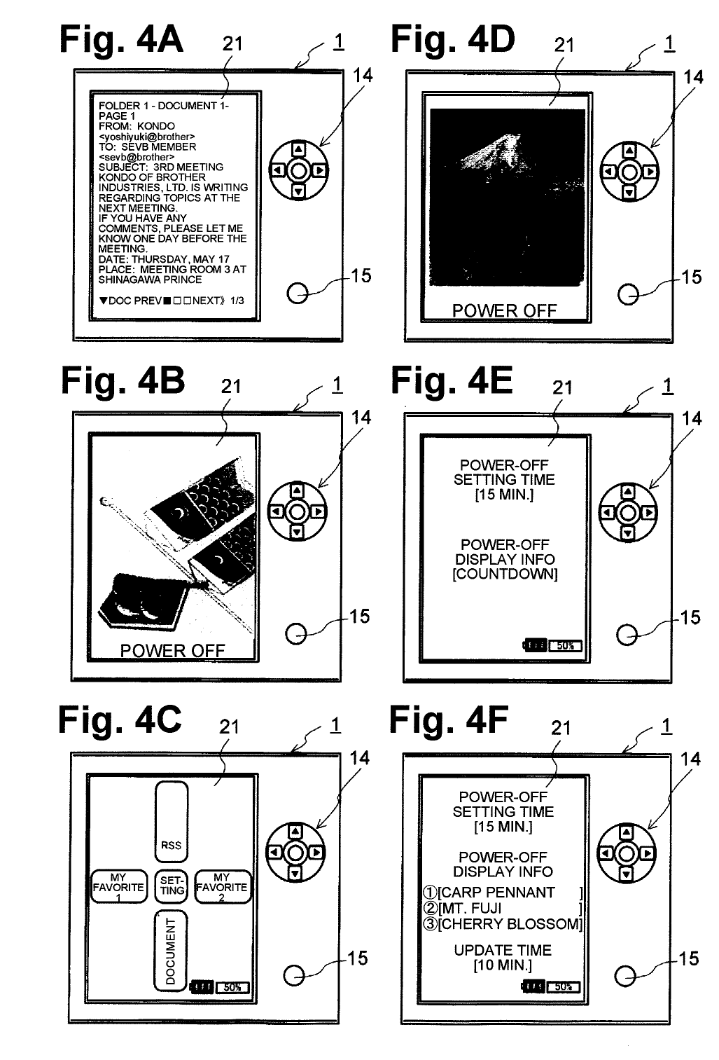

In an embodiment of the invention, a lower portion, e.g., a footer portion, of display portion 21 also may display information, such as a page number. When device 1 is in a power-on state, then when power key 15 is pressed, or any of operation keys 14 is not pressed for the power-off setting time period, power may be turned off, and device 1 may transition to a power-off state. At this time, display portion 21 may display the set power-off display information, e.g., an image of a carp pennant, and a message, e.g., a “Power off” message at the lower portion of display portion 21, as shown in FIG. 4B.

As shown in FIG. 4B, when device 1 is in a power-off state, then when power key 15, or any of operation keys 14, is pressed, power may be turned on, and device 1 may transition to a power-on state. At this time, display portion 21 may display a top page, e.g., a top page as shown in FIG. 4C, in its display area.

As shown in FIG. 4B, when power key 15 is not pressed for a certain period of time, power-off display information, e.g., an image of Mt. Fuji as shown in FIG. 4D, which may be different from the power-off display information shown in FIG. 4B, may be displayed in display portion 21. More specifically, as a certain period of time has elapsed since power is turned off, power may be turned on and information that previously was displayed when device 1 was in a power-off state may be changed or replaced with another power-off display information.

A predetermined operation of one or more of operation keys 14 may cause a screen, e.g., a screen showing the power-off setting time and the power-off display information, as shown FIG. 4E, to be displayed on display portion 21. When such a screen appears, a user of device 1 may set the power-off setting time and the device-based power off display information, using operation keys 14 on the screen shown in FIG. 4E. When the power-off setting time has been set, while device 1 is in a power-on state, when the power-off setting time elapses without an operation of any operation keys 14, power to device 1 may be turned off.

More than one piece, e.g. a plurality of pieces of power-off display information may be set for device 1, as shown in FIG. 4F. When more than one piece, e.g., a plurality, of power-off display information is set for device 1, a an order for displaying each of the plurality of the pieces of power-off display information may be set. Additionally, the power-off display information may be set for device 1 via an operation carried out by device 1. In an embodiment of the invention, the power-off display information may be set for a content with an operation in external device 200. When pieces of power-off display information are set, power-off display information displayed in display portion 21 may be changed or updated at each update time. An update time, e.g., 10 minutes, may be set in EEPROM 18.

When a setting, e.g., the setting shown in FIG. 4F, is made, a first power-off display information, e.g., an image of the carp pennant shown in FIG. 4B may be displayed in display portion 21, if any operation keys 14 are not operated for a certain time, e.g., 15 minutes. Then, after the certain time has elapsed without operation of any of operation keys 14, power may be turned off, e.g., device 1 may transition to a power-off state. Thereafter, if the update time period, e.g., 10 minutes, elapses without an operation of any of operation keys 14, a second power-off display information, e.g., an image of Mt. Fuji, as shown in FIG. 4D, may be displayed in display portion 21. Thereafter, if the update time period, e.g., 10 minutes, elapses again without an operation of any of operation keys 14, a third power-off display information, e.g., an image of a cherry blossom (not shown), may be displayed in display portion 21. Thereafter, if the update time period, e.g., 10 minutes, further elapses without an operation of any of operation keys 14, the first power-off display information, e.g., a carp pennant, again may be displayed in display portion 21.

When a schedule is set as power-off display information, the schedule, e.g., the schedule of a day may be displayed in display portion 21 when device 1 is in a power-off state, based on date information. The date information may represent the present year, month, and day, and may be updated based on the time measured by RTC 19. The date information may be stored in EEPROM 18. As shown in FIG. 5A, the schedule of a day e.g., March 19, corresponding to the date stored in the date information may be displayed in display portion 21. When device 1 is in a power-off state at a time when the date information is updated, power may be temporarily turned on, e.g., device 1 may briefly transition to a power-on state, then back to a power-off state. Based on the updated date information, the schedule of the next day, e.g., March 20 in the example, may be displayed in display portion 21, as shown in FIG. 5B.

When a countdown is set as power-off display information, as shown in FIG. 5C, or when a calendar is set as power-off display information, as shown in FIG. 5D, device 1 power, which may be off, e.g., device 1 is in a power-off state, may be temporarily turned on at a predetermined timing, e.g., when the date information is updated, similar to the above schedule. When power to device 1 is temporarily turned on, updated countdown or calendar may be displayed in display portion 21, and device 1 again may return to the power-off state.

For example, when a weather forecast, as shown in FIG. 5E, is set as the power-off display information, then power to device 1, which is off, may be temporarily turned on at a predetermined timing, e.g., every few hours, and the updated weather forecast may be displayed in display portion 21 when device 1 again returns to the power-off state. In an embodiment of the invention, power-off display information may be pre-stored in memory card 23. In an embodiment of the invention, when power to device 1 is temporarily turned on, power-off display information corresponding to that time may be obtained from server 300, via communication unit 25.

An advertisement, e.g., the advertisement shown in FIG. 5F, may be set as power-off display information, in association with a content. For example, an advertisement for a comic book may be set as power-off display information for a content, e.g., a weekly comic magazine. When a user downloads a weekly comic magazine from a server 300 via a communication network, the weekly comic magazine may be downloaded together with an advertisement for a comic book. If the content of the weekly comic magazine is displayed in display portion 21 immediately before power is off, then when device 1 transitions to the power off state, the advertisement of the comic book may be displayed when power to device 1 is turned off, in association with the weekly comic magazine. The advertisement may be updated based on conditions. For example, an advertisement including the publication date of a comic book may be changed to an advertisement for the comic book being on sale, at the timing when the comic book is published.

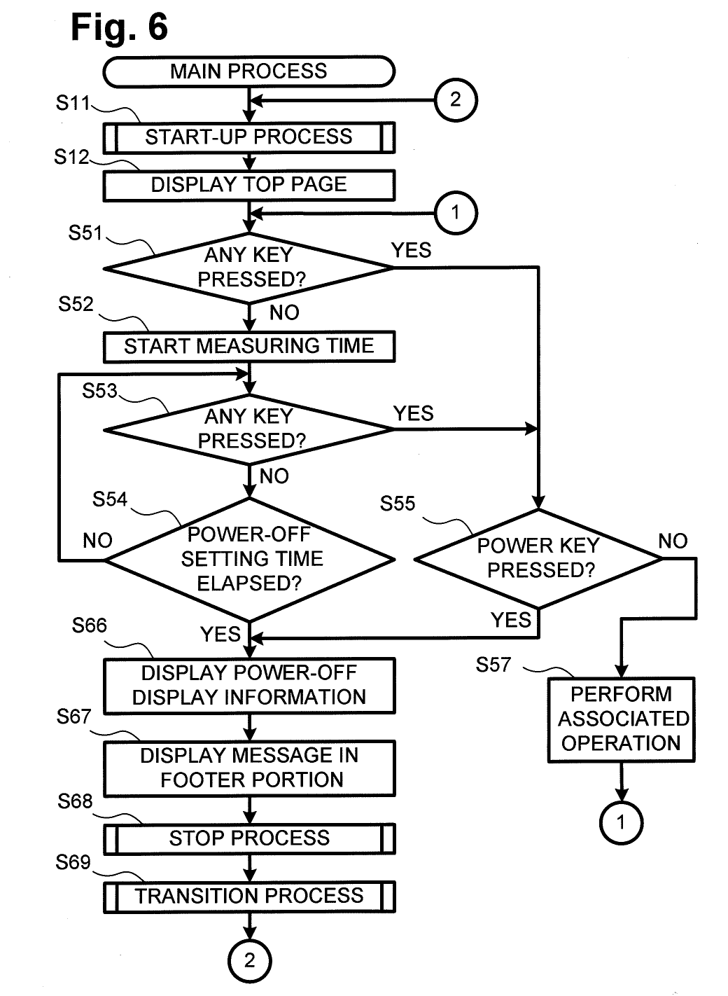

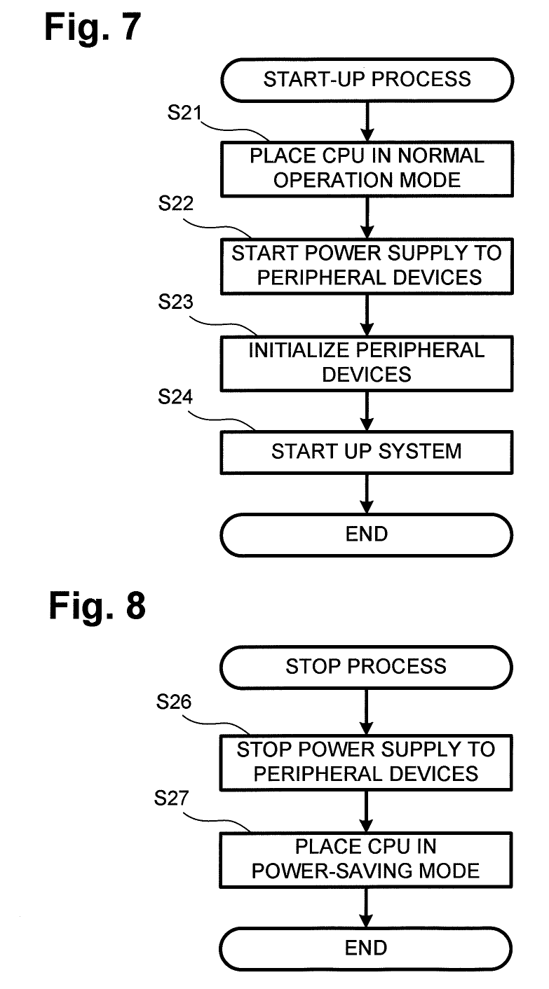

FIG. 6 shows a power-on process which may be performed when device 1 is in a power-off state. In an embodiment of the invention, the power-on process may be performed, e.g., when power key 15 or operation key 14 is pressed. When the power-on process starts, then at Step S11, CPU 10 may execute a start-up process. The start-up process will be described in more detail herein, specifically with reference to FIG. 7. At Step S12, CPU 10 may display a top page, e.g., the top page shown in FIG. 4C, in display portion 21.

At Step S51, CPU 10 may determine whether any key, e.g., one of operation keys 14 or power key 15, is pressed. When CPU 10 determines that any key is pressed, e.g., “YES” at Step S51, processing may proceed to Step S55. When CPU 10 determines that a key has not been pressed, e.g., “NO” at Step S51, then processing proceeds to Step S52, at which time measurement may start to measure elapsed time, to compare to a power-off setting time. Then, processing may proceed to Step S53.

At Step S53, CPU 10 again may determine whether any key is pressed. When CPU 10 determines that any key, e.g., any of operation keys 14 or power key 15 is pressed, e.g., “YES” at Step S53, processing may proceed to Step S55. When CPU 10 determines that a key has not been pressed, e.g., “NO” at Step S53, then processing may proceed to Step S54. At Step S54, CPU 10 may determine in Step S54 whether the power-off setting time has elapsed. The power-off setting time may be stored in EEPROM 18 in Step S103 or Step S104 of FIG. 7, discussed in more detail herein. When CPU 10 determines the power-off setting time has elapsed, e.g., “YES” at Step S54, then processing may proceed to Step S66. When CPU 10 determines the power-off setting time has not elapsed, e.g., “NO” at Step S54, processing may return to Step S53.

If a key is pressed, e.g., “YES” at Steps S51 or S53, then at Step S55, CPU 10 may determine whether the key pressed is power key 15. When CPU 10 determines that the key pressed is power key 15, e.g., “YES” at Step S55, then processing may proceed to Step S66. When CPU 10 determines that the key pressed is not power key 15, e.g., “NO” at Step S55, then processing may proceed to Step S57. At Step S57, CPU 10 may perform an operation in association with the pressed key. After CPU 10 performs the operation, processing may return to Step S51.

When device 1 is in a power-on state, and the power-off setting time elapses without any key operation, e.g., “YES” at Step S54, processing may proceed to Step S66. When power key 15 is pressed in a power-on state, processing also may proceed to Step S66. CPU 10 may display power-off display information, based on settings in the power-off display table, in Step S66. CPU 10 may read from the power-off display table for a setting corresponding to the contents displayed in display portion 21 in a power-on state, before device 1 transitions to a power-off state. Based on the setting read from the power-off display table, power-off display information may be displayed in display portion 21.

When more than one, e.g., a plurality of, pieces of power-off display information is set for a content, CPU 10 may display in display portion 21 one piece of power-off display information that may be set as the first information to be displayed. When the power-off display table for contents does not store a power-off display information setting for a content displayed in display portion 21 when device 1 is in a power-on state, power-off display information for the content may be displayed based on the settings in the power-off display table for device. When the device-based setting is set in the power-off display information for contents for a content being displayed in display portion 21, CPU 10 may display in display portion 21, power-off display information set in the power-off display table for device, in a power-off state.

At Step S67, the message, “Power off” may be displayed in the lower portion of the display area of display portion 21, e.g., footer portion. Then, processing may proceed to Step S68. CPU 10 may execute a stop process in Step S68 to stop device 1. The stop process will be described in more detail herein, with reference to FIG. 8.

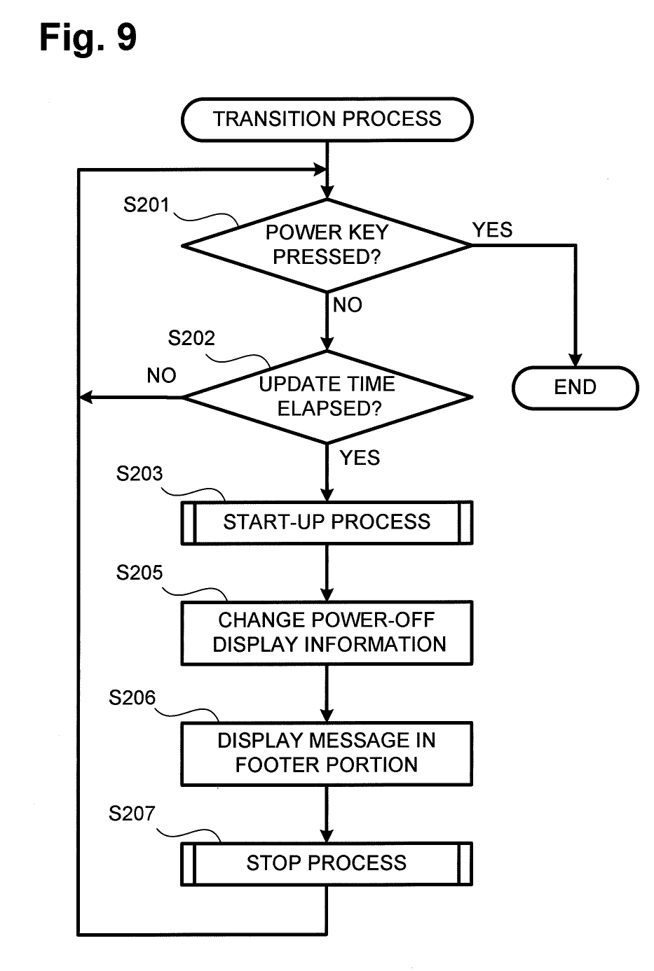

After Step S68, processing may proceed to Step S69 in which CPU 10 may execute a transition process. During the transition process, power may be temporarily turned on to change information displayed when device 1 is in a power-off state, and power then may be turned off again. The transition process will be described in more detail herein, with reference to FIG. 9. Thereafter, processing may proceed to Step S11.

The start-up process, as shown in FIG. 7, may be invoked in Step S11 of FIG. 6. As shown in FIG. 7, at Step S21, an operational mode of CPU 10 may change from a power-saving mode to a powered operation mode. At Step S22, power supply to the peripheral devices may start. At Step S23, CPU 10 may initialize the peripheral devices. At Step S24, CPU 10 may start up a system. With the start-up of the system, subsequent steps and other procedures may be performed in accordance with operation of device 1.

The stop process, as shown in FIG. 8, may be invoked in Step S68 of FIG. 6. As shown in FIG. 8, at Step S26, CPU 10 may suspend power supply to the peripheral devices. At Step S27, the operation mode of CPU 10 may change to the power-saving mode. Thus, device 1 may be placed in a power-off state.

The transition process, as shown in FIG. 9, may be invoked in Step S69 of FIG. 6. As shown in FIG. 9, at Step S201, CPU 10 may determine whether power key 15 is pressed. When CPU 10 determines that power key 15 is pressed, e.g., “YES” at Step S201, the process shown in FIG. 9 may end, and processing may proceed to Step S11 of FIG. 6. In other words, pressing of power key 15 when device 1 is in a power-off state may cause power to be turned on, e.g., may cause device 1 to transition to a power-on state. When CPU 10 determines that power key 15 is not pressed, e.g., “NO” at Step S201, processing may proceed to Step S202.

At Step S202, CPU 10 may determine whether an update time corresponding to the power-off display information displayed in display portion 21 has elapsed. More specifically, if a schedule, countdown, or calendar is set as the power-off display information in association with a content, as described above, the power-off display information may correspond to an update time for updating the power-off display information. In an embodiment of the invention, CPU 10 may determine that the update time has elapsed at a timing when the date information is updated. If the power-off display information in association with a content is set as a weather forecast, CPU 10 may determine that the update time has elapsed each time a certain number of hours elapses. When a plurality of pieces of power-off display information is set for a content, CPU 10 may determine that the update time has elapsed based on the lapse of the update time preset in EEPROM 18.

When CPU 10 determines that the update time has not elapsed, e.g., “NO” at Step S202, processing may return to Step S201. When CPU 10 determines that the update time has elapsed, e.g., “YES” at Step S202, processing may proceed to Step S203. At Step S203, CPU 10 may execute the start-up process to start up device 1. At Step S205, CPU 10 may change the power-off display information. Specifically, CPU 10 may temporarily turn power on at a timing when the update time has elapsed, to change the information displayed in display portion 21. At Step S206, CPU 10 may display a message, e.g., “Power off” in the footer portion. At Step S207, CPU 10 may execute the stop process. Then, processing may return to Step S201.

In an embodiment of the invention, when device 1 is in a power-off state, CPU 10 may repeatedly turn power on at a predetermined timing, e.g., a preset time or a preset period of time, to change information displayed in display portion 21. Even in a state of power-off, power may be turned on at a predetermined timing to change information displayed in display portion 21. The timing when information is changed may be preset to a specific time or period of time, which may allow a user recognize the time or period of time. Thus, changing or updating, e.g., schedule, calendar, or countdown, every preset time or period of time may be convenient.

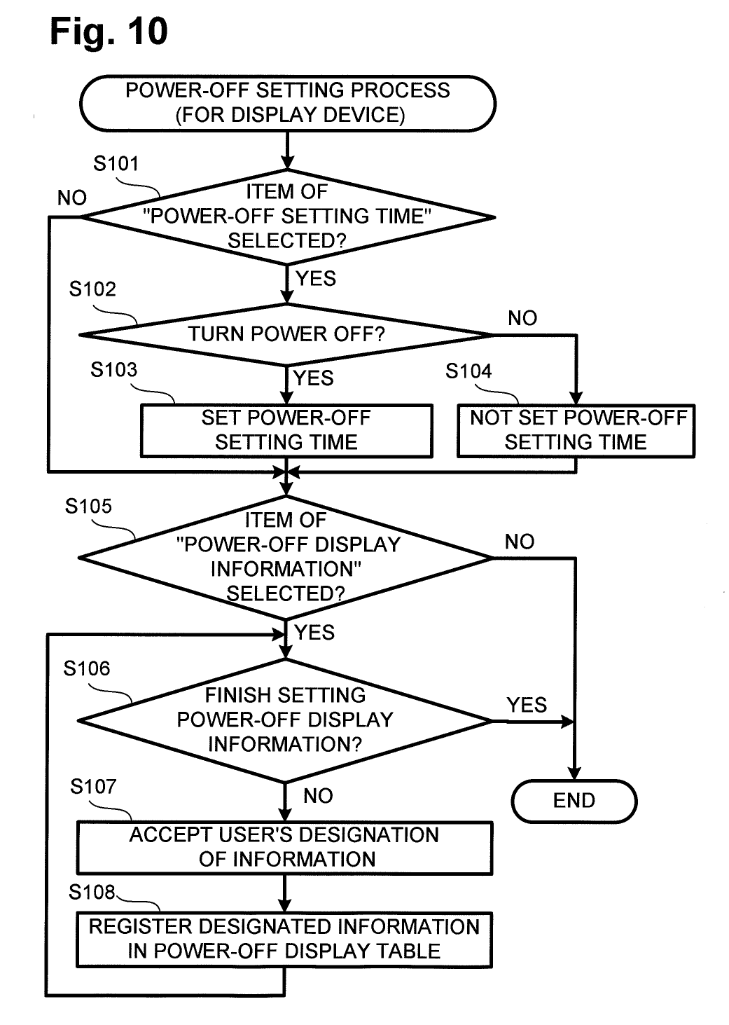

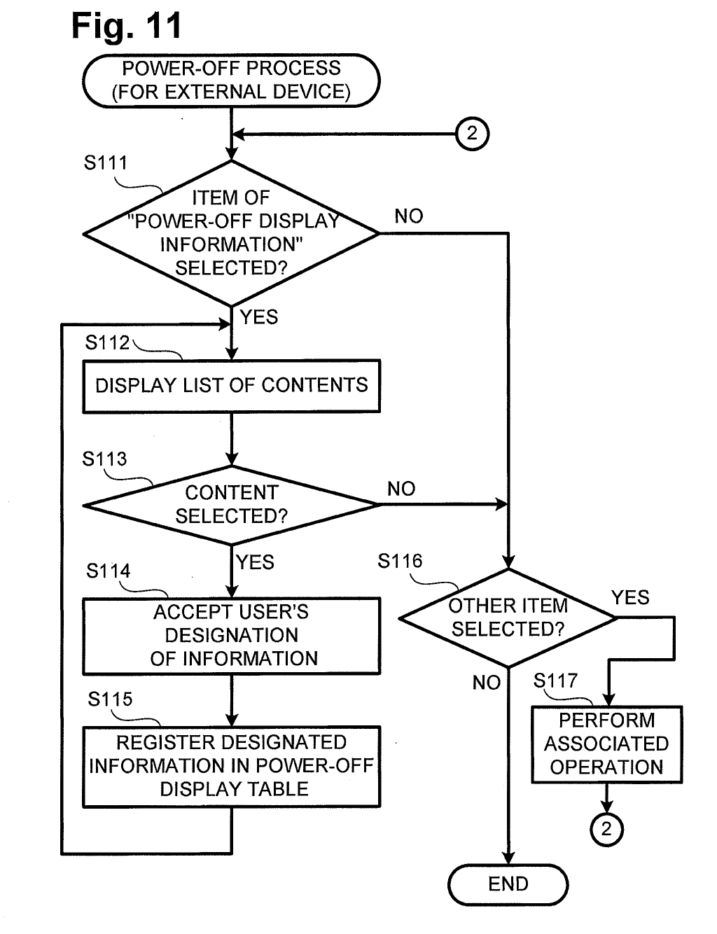

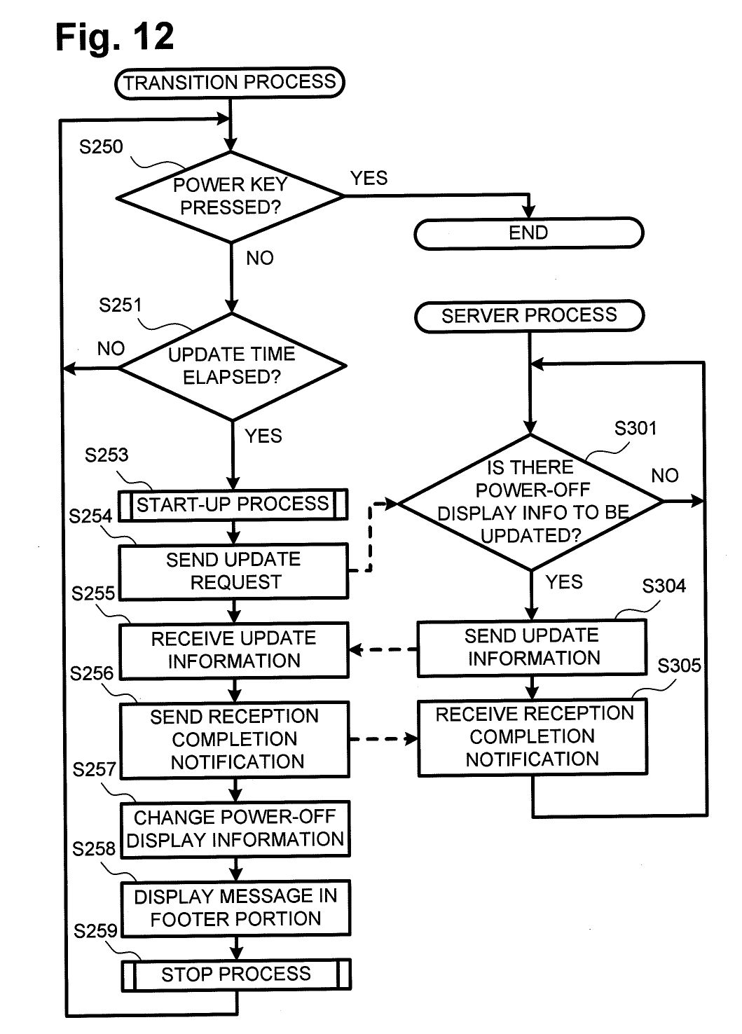

Referring to FIG. 10, a power-off setting process may be performed in device 1 to set a power-off setting time and/or power-off display information. When a user performs a predetermined operation in device 1 when device 1 is in a power-on state, a screen, e.g., the screen shown in FIG. 4F, may be displayed. Thereafter, the power-off setting process may be invoked. The screen may display items to set a power-off setting time and power-off display information.

When the power-off setting process is invoked, then at Step S101, CPU 10 may determine whether the operation of operation keys 14 has led to selection of the “power-off setting time” item. When CPU 10 determines that the “power-off setting time” item is selected, e.g., “YES” at Step S101, CPU 10 may display a message to encourage a user to select whether to enable an auto-power off function to automatically turn power off. The user's selection may be selected using operation keys 14. At Step S102, CPU 10 may determine whether the auto-power off function power is enabled, e.g., whether power to device 1 is turned off after lapse of the setting time. This determination may be based on the user's selection. When CPU 10 determines that power to device is turned off after the setting time elapses, e.g., “YES” at Step S102, CPU 10 may display a message to allow a user to input the power-off setting time. At Step S103, CPU 10 may read the value input by the user, and set this value as the power-off setting time. Then, CPU 10 may display a screen, such as the screen shown in FIG. 4F. Then, processing may proceed to Step S105.

When CPU 10 determines that power to the device 1 is not to be turned off after the power-off setting time lapses, e.g., “NO” at Step S102, then at Step S104, CPU 10 may not set the power-off setting time, and may display a screen, e.g., the screen shown in FIG. 4F. Then, processing may proceed to Step S105. Similarly, when CPU 10 determines that the item of “power-off setting time” is not selected, e.g., “NO” at Step S101, processing may proceed to Step S105.

At Step S105, CPU 10 may determine whether operations of operation keys 14 have selected an item of “power-off display information.” When CPU 10 determines that the item of “power-off display information” has been selected, e.g., “YES” at Step S105, then at Step S106, CPU 10 may display a message to allow a user to set the power-off display information, and determine whether an operation to set power-off display information is finished. When CPU 10 determines that the operation to set power-off display information is not finished, e.g., “NO” at Step S106, processing may proceed to Step S107. When CPU 10 determines that an operation to set power-off display information is finished, e.g., “YES” at Step S106, or when the item of “power-off display information” is not selected, e.g., “NO” at Step S105, processing may end.

At Step S107, CPU 10 may accept a user's designation of the information to be displayed in a power-off state, e.g., power-off display information. Moreover, at Step S107, information stored in memory card 23 may be designated. At Step S108, CPU 10 may register the information designated by a user in the power-off display table for device. Then, processing may return to Step S106. CPU 10 may store one or more pieces of information, e.g., information 1, information 2, or information 3, designated by a user's operation using operation keys 14. These one or more pieces of information may be stored in the power-off display table for device.

CPU 10 may register the information designated by a user in the power-off display table for device in Step S108. Processing may return to Step S106. CPU 10 may store in the power-off display table for device, one or more pieces of information, e.g., information 1, information 2, or information 3, designated by a user's operation using operation keys 14. In an embodiment of the invention, in the power-off setting process, the update time may not be selected. Nevertheless, such a structure may be adopted that enables the selection of an item of “update time” by a user when a plurality of pieces of power-off display information is set to one object.

FIG. 11, describes a power-off setting process that may be invoked by a predetermined operation in external device 200, according to an embodiment of the invention. The process may be executed after a predetermined operation is performed in external device 200, and a menu screen is displayed in display portion 221. The menu screen may list a plurality of selectable items, one of which may be the “power-off display information.” Referring to FIG. 11, at Step S211, CPU 210 may determine whether operation portion 214 selects a “power-off display information” item When CPU 210 determines that the “power-off display information” is selected, e.g., “YES” at Step S111, CPU 210 may display a list of contents stored in memory card 23 in display portion 221 at Step S112. CPU 210 also may display a message to allow a user to select a content to which the power-off display information may be set. At Step S113, CPU 210 may determine whether the user selected a content. When CPU 210 determines that the user selected a content, e.g., “YES” at Step S113, processing may proceed to Step S114.

When CPU 210 determines that the item of “power-off display information” is not selected, e.g., “NO” at Step S111, or when CPU 210 determines that the user did not select a content, e.g., “NO” at Step S113, processing may proceed to Step S116. At Step S116, CPU 210 may determine whether an other item is selected from the menu. When CPU 210 determines that an other item is selected from the menu, e.g., “YES” at Step S116, then at Step S117, an operation associated with the selected other item may be performed. Then, processing may return to Step S111. When CPU 210 determines that an other item is not selected from the menu, e.g., “NO” at Step S116, processing may end.

At Step S114, CPU 210 may accept a user's designation of information to be displayed in power-off state, e.g., the power-off display information may be set. Further, at Step S114, information stored in memory card 23 or HDD 218 may be designated. At Step S115, CPU 210 may register the information designated by a user as a setting of the power-off display information corresponding to the content selected in Step S112. The designated information may be stored in the power-off display table for contents. In an embodiment of the invention, if memory card 23 does not pre-store data, e.g., image data, of the information registered as the setting of power-off display information in the power-off display table for contents, then at Step S115, CPU 210 may store the data of the information designated by a user in memory card 23. Processing then may return to Step S112.

CPU 210 may store, in the power-off display table for contents, one or more pieces of information, e.g., advertisements 1 and 2, which may be set to document G as shown in FIG. 3B, as the information associated with a content displayed in a power-on state, immediately before power is turned off. With operations of operation portion 214, CPU 210 may store the information to be displayed in a power-off state in association with a content, in memory card 23. CPU 10 of device 1 may read memory card 23 and display the information, e.g., advertisements 1 and 2, which may be set to document G as shown in FIG. 3B, in association with the content being displayed immediately before power is turned off.

Device 1 may change the information displayed in display portion 21 by repeatedly turning power on at a predetermined timing when device 1 is in a power-off state. Thus, even in a power-off state, power may be turned on at a predetermined timing to change or update information displayed in display portion 21.

In an embodiment of the invention, CPU 10 may correspond to a controller. Display portion 21 may correspond to a non-volatile display portion. Operation keys 14 may correspond to an operation device. EEPROM 18 and memory card 23 may correspond to an information storage portion.

In the above-described embodiment, the power-off display table for device shown in FIG. 3A may be updated in device 1. The power-off display table for contents shown in FIG. 3B may be updated in external device 200. In another embodiment, the power-off display table for contents may be updated in device 1, and the power-off display table for device may be updated in external device 200.

In an embodiment, power-off display information may be set for each content. In another embodiment, power-off display information may be set for each folder containing contents or may be set according to content types, content names, e.g., the first letter of the contents, confidentiality of contents, security levels of contents, or time when power is turned off. In another embodiment, power-off display information associated with information displayed in display portion 21 may be stored in a folder, which may store the information displayed in display portion 21. In yet another embodiment, power-off display information associated with information displayed in display portion 21 may be the same information type as that of the information displayed in display portion 2

Further, power to device 1 may be temporarily turned on, e.g., device 1 may transition to a power-on state, then transition back to a power-off state, at a timing when a content or power-off display information associated with the content is downloaded from server 300 via a network, to change power-off display information. A content or power-off display information downloaded from server 300 may be a new content or information, or an updated content or information. FIG. 12 describes this process according to an embodiment of the invention.

As shown in FIG. 12, a transition process may be invoked in Step S69 of FIG. 6. At Step S250, CPU 10 may determine whether power key 15 is pressed. When CPU 10 determines that power key 15 is pressed, e.g., “YES” at Step S250, the process will end and processing may return to Step S11 of FIG. 6. Again referring to FIG. 12, at Step S250, when CPU 10 determines that power key 15 is not pressed, e.g., “NO” at Step S250, processing may proceed to Step S251.

At Step S251, CPU 10 may determine whether the update time corresponding to a content being displayed in display portion 21 has elapsed, similar to the determination made at Step S202 of FIG. 9. When CPU 10 determines that the update time has not elapsed, e.g., “NO” at Step S251, processing may return to Step S250. When CPU 10 determines that the update time has elapsed, e.g., “YES” at Step S251, processing may proceed to Step S253. At Step S253, CPU 10 may execute the start-up process. At Step S254, CPU 10 may send an update request to sever 300.

Transitioning to the actions of server 300, at Step S301, CPU 310 of server 300 may determine whether there is power-off display information to be updated, e.g., whether an update request is received from device 1. When CPU 310 determines that there is power-off display information to be updated, e.g., “YES” at Step S301, processing may proceed to Step S304. When CPU 310 determines that there is no power-off display information to be updated, e.g., “NO” at Step S301, processing may return and execute Step S301 again. Thus, CPU 310 may continuously monitor whether there is power-off display information to be updated, e.g., whether device 1 sends the update request to server 300.

When CPU 310 determines that there is power-off display information to be updated, e.g., “YES” at Step S301, then at Step S304, CPU 310 may send updated power-off display information to device 1. Thereafter, processing may proceed to Step S305, in which CPU 310 may receive reception completion notification from device 1. When CPU 310 of server 300 receives reception completion notification from device 1, processing may return to Step S301.

Transitioning back to the actions of device 1, at Step S255, CPU 10 of device 1 may receive the updated power-off display information from server 300 (sent from Step S304, as set forth above). Upon successful receipt of the updated power-off display information, CPU 10 may send a reception completion notification to server 300 at Step S256. At Step S257, CPU 10 then may replace the power-off display information that previously had been displayed in display portion 21 with the received power-off display information. At Step S258, CPU 10 may display a message, e.g., “Power off” at the footer portion. At Step S259, CPU 10 may execute the stop process, and processing may return to Step S250 to check for power key 15 pressed, or update time again elapsing.

In an embodiment of the invention, CPU 10 may send a request for updated information to server 300, which may store information to be displayed in display portion 21, after power is turned on, at a predetermined timing. CPU 10 may receive the updated information from server 300 to change the information displayed in display portion 21. Thus, CPU 10 may receive the updated information from server 300 in reply to a request sent to server 300. CPU 10 may replace the information displayed in display portion 21 with the information stored in server 300, which may be convenient.

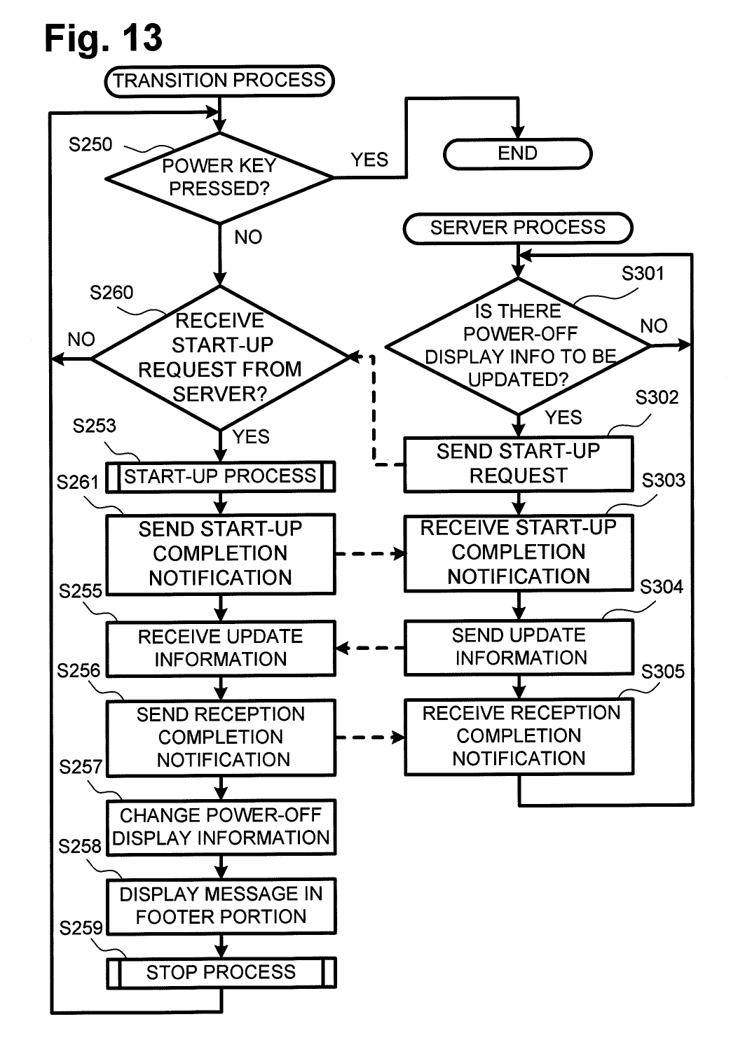

In the above embodiment, power-off display information may be changed by device 1 sending a request to server 300. In another embodiment, power-off display information may be changed by server 300 sending a request to device 1. FIG. 13 illustrates this process according to an embodiment of the invention.

In an embodiment of the invention, a transition process of FIG. 13 may be invoked in Step S69 of FIG. 6. When CPU 20 determines that power key 15 is not pressed, e.g., “NO” at Step S250, then at Step S260, CPU 10 may determine whether a start-up request is sent from server 300. When CPU 310 determines, based on information pre-stored in server 300, that there is power-off display information to be updated, e.g., “YES” at Step S301, CPU 310 may determine a device to which the update power-off display information should be sent. CPU 310 may refer to a record of transmitted power-off display information, which may be associated with the update power-off display information. At Step S302, CPU 310 may send a start-up request to device 1 to which the updated power-off display information may be transmitted.

Transitioning to the actions carried out in device 1, when CPU 10 receives the start-up request from server 300, e.g. “YES” at Step S260, processing may proceed to Step S253, in which the start-up process may be performed, similar to Step S253 of FIG. 12. Referring again to FIG. 13, at Step S261, CPU 10 may send start-up completion notification to server 300. Transitioning to the actions carried out in server 300, at Step S303, server 300 receives the start-up completion notification, and processing moves to Step S304, at which updated information is sent to device 1, similar to Step S304 of FIG. 12. CPU 10 of device 1 then receives the updated information at Step S256, and transmits a reception completion notification at Step S257, similar to Steps S256 and S257 of FIG. 12. Then, CPU 310 of server 300, at Step S305, receives the reception completion notification from device 1, similar to Step S305 of FIG. 12. Thereafter, CPU 10 carries out Steps S258 and S259 as in FIG. 12.

CPU 10 may determine, when device 1 is in a power-off state, a predetermined timing based on the time when CPU 10 receives the start-up request from server 300, which stores the information to be displayed in display portion 21. At the predetermined timing, power may be turned on, e.g., device 1 may transition from a power-off state to a power-on state, to receive the updated information. CPU 10 may receive and obtain the updated information from server 300, and change the information displayed in display portion 21. Thus, information displayed in display portion 21 may be replaced with information stored in server 300, which may be convenient.

In the above embodiments, EEPROM 18 or memory card 23 may store contents or information about settings of the power-off display table. EEPROM 18 or memory card 23 may store contents that may be supplied from another device. Further, contents or information about settings of the power-off display table may be stored in EEPROM 18 of device 1, via a USB cable or other similar connection.

While the invention has been described in connection with various exemplary structures and illustrative embodiments, it will be understood by those skilled in the art that other variations and modifications of the structures and embodiments described above may be made without departing from the scope of the invention. Other structures and embodiments will be apparent to those skilled in the art from a consideration of the specification or practice of the invention disclosed herein. It is intended that the specification and the described examples are illustrative with the true scope of the invention being defined by the following claims.

What is claimed is:

1. A portable display device configured to transition between a first state and a second state, the portable display device comprising:
a display portion configured to display information when the portable display device is in the first state and to display a particular information when the portable display device is in the second state;
a power source configured to supply power when the portable display device is in the first state, and to supply less power when the portable display device is in the second state than when the portable display device is in the first state; and
a controller configured to drive the display portion to display information in the display portion,
wherein the controller is configured to replace the particular information displayed in the display portion with a further information different from the information displayed in the display portion, by transitioning the portable display device from the second state to the first state, and back to the second state, at a predetermined timing.

2. The portable display device of claim 1, wherein the controller is configured to repeatedly replace the information displayed in the display portion with the further information, by repeatedly transitioning the portable display device from the second state to the first state, and back to the second state, at the predetermined timing.

3. The portable display device of claim 1, wherein the controller is configured to repeatedly replace the information displayed in the display portion with the further information, by repeatedly transitioning the portable display device from the second state to the first state, and back to the second state, at predetermined time intervals.

4. The portable display device of claim 1, wherein when the portable display device is in the second state, the controller is configured to send a request, at the predetermined timing, for the further information to an external device configured to store the further information,
the controller is configured to obtain the further information from the external device when the device transitions from the second state to the first state, and
the controller is configured to display the further information obtained from the external device, when the device transitions from the first state back to the second state.

5. The portable display device of claim 1, wherein the controller is configured to receive a device start request from an external device that stores the further information, determine the predetermined timing upon receipt of the device start request, transition the device from the second state to the first state at the predetermined timing, obtain the further information from the external device, and to display the further information in the display portion when the device transitions to the second state.

6. The portable display device of claim 1, further comprising an information storage portion configured to store one or more pieces of information to be displayed in the display portion when the portable display device is in the second state, and wherein the controller is configured to repeatedly select one piece of information from the one or more pieces of information stored in the information storage portion at the predetermined timing, and is configured to display the selected one piece of information in the display portion when the device is in the second state.

7. The portable display device of claim 6, wherein the one or more pieces of information comprises a plurality of pieces of information.

8. The portable display device of claim 7, wherein an associated information comprises information associated with the information displayed in the display portion immediately before the portable display device transitions from the first state to the second state, and
wherein when the device is in the second state, the controller is configured to display the associated information, among the plurality of pieces of information stored in the information storage portion.

9. The portable display device of claim 8, wherein the associated information is stored in a folder, which stores one of the information displayed in the display portion and information that is a same information type as that of the information displayed in the display portion.

10. A computer program product having computer readable instructions stored thereon, which, when executed by a processor of a portable display device, configures the processer to perform the steps of:
driving a display portion to display information when the portable display device is in a first state, the first state corresponding to the portable display device receiving a power supply from a power source;
displaying a particular information when the portable display device is in a second state, the second state corresponding to the portable display device receiving less power supply from the power source than when the portable display device is in the first state;
transitioning the portable display device from the second state to the first state;
replacing the particular information with a further information different from the information displayed in the display portion;
transitioning the portable display device from the first state to the second state; and
displaying the further information when the portable display device returns to the second state.

11. The computer program product of claim 10, further comprising computer readable instructions stored thereon, which, when executed by a processor of a portable display device, configures the processer to perform the further step of
repeatedly executing the steps of displaying a particular information, transitioning the portable display device from the second state to the first state, replacing the information displayed in the display portion with the further information different from the information displayed in the display portion, transitioning the portable display device from the first state to the second state, and displaying the further information in the display portion.
